(19) United States
(12) Patent Application Publication
(10) Pub. No.: US 2006/0205916 A1
(43) Pub. Date: Sep. 14, 2006

(54) Methods for preparing polyester-based nanocomposites

(75) Inventors: Tohru Takekoshi, Scotia, NY (US); Steven R. Bahr, Schenectady, NY (US)

Correspondence Address: GOODWIN PROCTER LLP;PATENT ADMINISTRATOR, EXCHANGE PLACE, BOSTON, MA, 02109-2881, US

(73) Assignee: Cyclics Corporation, Schenectady, NY (US)

(21) Appl. No.: 11/367,788

(22) Filed: Mar. 3, 2006

Related U.S. Application Data
(60) Provisional application No. 60/661,096, filed on Mar. 10, 2005.

(51) Int. Cl. C08G 63/02

(52) U.S. Cl. 528/272

(57) ABSTRACT

The invention provides methods for preparing composites of polyester and layered compounds. In one embodiment, the invention provides a method for preparing a composite of a poly(alkylene terephthalate) and a cation-modified layered compound via in-situ polycondensation in solvent. In another embodiment, composites are made with polyesters of average molecular weight of 10,000 g/mol or more by mixing the polyester and a layered compound in the presence of a solvent, such as ortho-dichlorobenzene.

### RELATED APPLICATION

This application claims benefit of U.S. Provisional Patent Application No. 60/661,096, filed on Mar. 10, 2005, the text of which is incorporated herein by reference in its entirety.

### FIELD OF THE INVENTION

This invention relates generally to methods for preparing composites of polyesters and layered compounds. More particularly, in certain embodiments, the invention relates to methods for preparing composites by conducting a polycondensation reaction in solvent and in the presence of a layered compound.

### BACKGROUND OF THE INVENTION

Poly(butylene terephthalate) (PBT) and poly(ethylene terephthalate) (PET)-based clay nanocomposites have been produced by mixing polymer and clay at temperatures at or above the melting point of the polymer in a process referred to as melt-mixing. However, nanocomposites produced by melt-mixing typically contain a mixture of intercalated and exfoliated clay structures, indicating inadequate dispersion.

Intercalated structures have a single layer or a few layers of polymer chains sandwiched between clay layers, while exfoliated clays are individually delaminated and are more fully dispersed in the polymer matrix. The presence of both intercalated and exfoliated clay structures within a nanocomposite is indicative of incomplete nano-scale dispersion. Incomplete dispersion limits the ultimate enhancement in properties that can be achieved with more thoroughly-dispersed, exfoliated clay.

The presence of both intercalated and exfoliated clay structures in melt-mixed nanocomposites is thought to be due to the high melt viscosity of PBT and PET, as well as the poor thermal stability of certain organoclays at the temperatures required for melt-mixing.

Aluminosilicate-based clays that have been modified by exchange of their inorganic cations with certain quaternary ammonium cations are compatible with molten polyesters such as PBT and can be used to form composites in which organoclay layers are exfoliated on the nano-scale. Melt-mixing of such clays with semi-crystalline polyesters—for example, PBT and PET—typically requires high temperatures (i.e. from about 220° C. to about 280° C. or higher) and high-shear mixing conditions because of the high melting temperatures and high melt viscosity of these polyesters. Under such conditions, however, quaternary ammonium ions are unstable. They typically decompose at temperatures above 180-200° C., yielding various byproducts when melt-mixed with polyester, and causing a reduction in the molecular weight of the polyester. This renders nanocomposites produced thereby non-useful.

U.S. Pat. No. 5,530,052 to Takekoshi et al. describes methods of producing composites by performing a ring-opening polymerization of a macrocyclic polyester oligomer in the presence of cation-modified clay. However, new methods are needed that do not require the use of macrocyclic polyester oligomers.

### SUMMARY OF THE INVENTION

A polyester-based nanocomposite can be created by performing a polycondensation reaction in a solvent and in the presence of a layered compound, such as a clay or other mineral.

For example, a nanocomposite can be made by polymerizing dimethyl terephthalate and butanediol to form PBT in the presence of a thermally-stable cation-modified clay—for example, an imidazolinium-modified organoclay. The reaction is performed in a solvent, such as ortho-dichlorobenzene, and in the presence of a polymerization catalyst.

Certain solvents can be used to achieve a substantially homogeneous nano-scale dispersion of a layered compound in a polymer, for example, at a temperature well below the melting point of the polymer. Accordingly, low-heat, low-shear methods for preparing polyester-based composites using a solvent as a solubilizer and dispersing agent are described herein. Mixing at lower temperatures and/or at lower shear allows the use of clays treated with materials, such as quaternary ammonium cations, that are unstable at higher temperatures and/or at higher shear conditions. Mixing at lower temperatures and/or at lower shear also reduces or eliminates the formation of clay decomposition byproducts that cause a reduction of polyester molecular weight during mixing, thereby preserving a high molecular weight polyester matrix. The use of a solvent lowers viscosity and provides enhanced clay dispersion in the polymer matrix, for example, allowing mixing at temperatures below the melting point of the polymer. It is even possible to directly mix high molecular weight polymer with cation-modified clay in solvent to form a nano-dispersed composition. Low-heat, low-shear methods for preparing polyester-clay composites in solvent provide increased versatility and can result in reduced manufacturing costs. Polycondensation is different from cyclic ring-opening polymerization, and methods described herein provide an alternative to performing a ring-opening polymerization of a macrocyclic polyester oligomer in the presence of cation-modified clay.

In one aspect, the invention provides a method for preparing a composite of a poly(alkylene dicarboxylate) and a layered compound by performing a polycondensation reaction in solvent and in the presence of the layered compound. In certain embodiments, the poly(alkylene dicarboxylate) includes, for example, poly(butylene terephthalate), poly(ethylene terephthalate), poly(propylene terephthalate), and/or copolymer(s) thereof. In one embodiment, the step of performing the polycondensation reaction includes reacting a diol and a dialkyl ester in the solvent and in the presence of the layered compound and a catalyst. In an alternative embodiment, the step of performing the polycondensation reaction includes reacting a diol and a carboxylic acid in the solvent and in the presence of the layered compound and a catalyst. The reaction may occur in one or more stages, any of which can be performed at atmospheric pressure, above atmospheric pressure, or below atmospheric pressure. The reaction may take place, for example, at temperatures above about 100° C., above about 120° C., above about 140° C., above about 160° C., above about 180° C., above about 200° C., above about 220° C., above about 240° C., above about 260° C., or above about 280° C. The reaction may take place, for example, at temperatures below about 340° C., below about 320° C., below about 300° C., below about 280° C., below about 260° C., below about 240° C., below about 220° C., below about 200° C., below about 180° C., or below about 160° C. The choice of reaction temperature will depend, for example, on the types and amounts of the particular reactants, layered compound(s), catalyst(s), and solvent(s) used. For example, quaternary ammonium cations may be unstable above about 200° C., and it is possible to avoid the production of decomposition byproducts (and the deactivation of catalyst that may result) by performing the polycondensation at lower temperatures while still obtaining a sufficient dispersion of the layered compound in the polymer matrix. By using cations that are more thermally-stable—for example, imidazolium and/or benzimidazolium cations—higher temperatures can be used while avoiding production of decomposition byproducts. For example, a temperature of 250° C. or more can be used, under autogenous pressure of the solvent.

The solvent can include, for example, tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether (or a halogenated derivative thereof), anisole, dimethoxybenzene, chlorobenzene, dichlorobenzene, trichlorobenzene, chloronaphthalene, dichloronaphthalene, and/or a perfluorocarbon. In one embodiment where the solvent is a perfluorocarbon, the polycondensation reaction is performed in a supercritical fluid process. In some embodiments, solvents with amine groups should be avoided; however, perfluoramine may behave differently from other amines and may be suitable for some embodiments.

In preferred embodiments, the polycondensation reaction is performed in the presence of a catalyst. The catalyst can include, for example, a metal oxide, antimony oxide, a transition metal salt, zinc acetate, cobalt acetate, a mercury salt, a lead salt, a cadmium salt, a manganese salt, a chromium salt, a molybdenum salt, a tungsten salt, a tin compound, and/or a titanate compound.

In preferred embodiments, the layered compound has undergone an ion exchange prior to its use in the polycondensation reaction. In certain embodiments, the layered compound has undergone cation exchange with quaternary ammonium cations, imidazolium cations, and/or benzimidazolium cations. In certain embodiments, the layered compound may have undergone cation exchange with cations having at least one positively charged organo-substituted heteroatom. For example, the positively charged organo-substituted heteroatom may include pyrrole, imidazole, thiazole, oxazole, pyridine, pyrimidine, quinoline, isoquinoline, indole, purine, benzimidazole, benzothiazole, benzoxazole, pyrazine, quinoxaline, quinazoline, acridine, phenazine, imidazopyridine, and/or dipyridyl. In certain embodiments, the layered compound includes (or is) a modified layered compound. For example, the modified layered compound may have been modified via cation exchange with an onium compound, for example, an ammonium salt, a phosphonium salt, a sulfonium salt, a pyrrolidine salt, a piperidine salt, a piperazine salt, and/or a morpholine salt.

In certain embodiments, the layered compound includes kaolinite, hallysite, dickite, nacrite, montmorillonite, nontronite, beidellite, hectorite, saponite, muscovite, vermiculite, an illite, a silicate, hydromicas, phengite, brammallite, glaucomite, celadonite, kenyaite, megadite, muscovite, sauconite, volkonskoite, a phyrophyllic, a mica, a smectite, biotite, limonite, graphite, and/or feldspar. In certain embodiments, the layered compound is an admixture of minerals. The layered compound is preferably introduced in its non-exfoliated state, but, in alternative embodiments, the layered compound may be introduced in a pre-exfoliated or partially-exfoliated form, prior to the polycondensation reaction. In certain embodiments, the prepared composite (following polycondensation) contains a layered compound (i) substantially all of which is in the form of exfoliated structures; (ii) substantially all of which is in the form of intercalated structures; or (iii) a portion of which is exfoliated and a portion of which is intercalated. In embodiments in category (iii), the weight ratio of exfoliated to intercalated structures may be, for example, greater than 0.3:0.7, greater than 0.5:0.5, greater than 0.75:0.25, or greater than 0.9:0.1.

One embodiment of the invention is directed to a composite produced by the polycondensation reaction in solvent and in the presence of the layered compound. In certain embodiments, this composite has GPC peak molecular weight, as calibrated in reference to polystyrene standard, of at least about 5,000 g/mol, at least about 10,000 g/mol, at least about 15,000 g/mol, at least about 20,000 g/mol, at least about 25,000 g/mol, at least about 30,000 g/mol, at least about 35,000 g/mol, at least about 40,000 g/mol, at least about 45,000 g/mol, at least about 50,000 g/mol, at least about 55,000 g/mol, at least about 60,000 g/mol, at least about 70,000 g/mol, at least about 80,000 g/mol, at least about 90,000 g/mol, or at least about 100,000 g/mol or more. The GPC peak value may correspond, for example, to an average molecular weight of the polymer matrix of the composite (GPC molecular weight is very close to weight average molecular weight). In certain embodiments, the composite is a nanocomposite, for example, where the individual particles of the layered compound have a size on the order of 0 to about 100 nanometers in at least one dimension.

In another aspect, the invention provides a method for preparing a composite of a poly(alkylene terephthalate) and a layered compound, the method including the step of contacting: (a) one or a combination of (i) a diol, (ii) a dialkyl ester, (iii) a carboxylic acid, and (iv) a reaction product of a diol and a dialkyl ester; (b) a solvent; (c) a layered compound; and (d) a catalyst. In certain embodiments, the poly(alkylene terephthalate) includes poly(butylene terephthalate), poly(ethylene terephthalate), poly(propylene terephthalate), and/or copolymer(s) thereof.

In one embodiment, the poly(alkylene terephthalate) includes poly(butylene terephthalate) and the contacting step includes contacting butanediol, dimethyl terephthalate, the solvent, the layered compound, and the catalyst (i.e. a polymerization catalyst). In another embodiment, the poly(alkylene terephthalate) includes poly(butylene terephthalate) and the contacting step includes contacting butanediol, terephthalic acid, the solvent, the layered compound, and the catalyst.

In preferred embodiments, the catalyst is a polycondensation catalyst. In certain embodiments, the catalyst includes, for example, metal oxide, antimony oxide, a transition metal salt, zinc acetate, cobalt acetate, a mercury salt, a lead salt, a cadmium salt, a manganese salt, a chromium salt, a molybdenum salt, a tungsten salt, a tin compound, and/or a titanate compound.

In preferred embodiments, the layered compound has undergone an ion exchange. In preferred embodiments, the layered compound is thermally stable at the temperature of the contacting step, for example, for at least the duration of the contacting step. In certain embodiments, the layered compound includes montmorillonite, kaolinite, and/or illite. In certain embodiments, prior to its use in the above-described contacting step, the layered compound has undergone cation exchange with quaternary ammonium cations, imidazolium cations, and/or benzimidazolium cations.

In one embodiment, the solvent includes dichlorobenzene, for example, ortho-dichlorobenzene (oDCB). In certain embodiments, the solvent includes, for example, tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether (or a halogenated derivative thereof), anisole, dimethoxybenzene, chlorobenzene, trichlorobenzene, chloronaphthalene, dichloronaphthalene, and/or a perfluorocarbon.

One embodiment of the invention is directed to a composite produced by the polycondensation reaction in solvent and in the presence of the layered compound. In certain embodiments, this composite has a GPC peak molecular weight, in reference to polystyrene standards, of at least about 5,000 g/mol, at least about 10,000 g/mol, at least about 15,000 g/mol, at least about 20,000 g/mol, at least about 25,000 g/mol, at least about 30,000 g/mol, at least about 35,000 g/mol, at least about 40,000 g/mol, at least about 45,000 g/mol, at least about 50,000 g/mol, at least about 55,000 g/mol, at least about 60,000 g/mol, at least about 70,000 g/mol, at least about 80,000 g/mol, at least about 90,000 g/mol, or at least about 100,000 g/mol or more. The GPC peak may correspond, approximately, to the average molecular weight of the polymer matrix of the composite. In certain embodiments, the composite is a nanocomposite, for example, where the individual particles of the layered compound have a size on the order of 0 to about 100 nanometers in at least one dimension.

In certain embodiments, a transesterification and/or a polycondensation takes place during the contacting step, for example, in the presence of the solvent.

In yet another aspect, the invention provides a method for preparing a composite including the step of mixing a polyester of average molecular weight greater than about 2,000 g/mol and a layered compound in the presence of a solvent, thereby forming a composite of the polyester and the layered compound. In certain embodiments, the polyester has average molecular weight greater than about 3,000 g/mol, greater than about 4,000 g/mol, greater than about 5,000 g/mol, greater than about 10,000 g/mol, greater than about 15,000 g/mol, greater than about 20,000 g/mol, greater than about 25,000 g/mol, greater than about 30,000 g/mol, greater than about 35,000 g/mol, greater than about 40,000 g/mol, greater than about 45,000 g/mol, greater than about 50,000 g/mol, greater than about 55,000 g/mol, greater than about 60,000 g/mol, greater than about 70,000 g/mol, greater than about 80,000 g/mol, greater than about 90,000 g/mol, or greater than about 100,000 g/mol or more. The polyester may be linear or branched, for example. The polyester may be substituted or unsubstituted, for example.

In one embodiment in which the layered compound has undergone cation exchange with quaternary ammonium cations, the mixing step is conducted at a temperature less than about 250° C., preferably less than 220° C., and more preferably less than about 200° C. Quaternary ammonium cations may be unstable above these temperatures, and it is possible to avoid the production of decomposition byproducts by performing the mixing step at these low temperatures while still obtaining a sufficient dispersion of clay (or other layered compound) in the polymer matrix. By using more thermally-stable cations, for example, imidazolium and/or benzimidazolium cations, higher temperatures can be used while avoiding production of decomposition byproducts. For example, a temperature of 250° C. or more can be used, under autogenous pressure of the solvent. However, it is possible that the thermal stability of the polyester may be compromised at higher temperatures; for example, the poly(butylene terephthalate) may degrade at temperatures above about 300° C. Thus, in certain embodiments, the mixing step is conducted at a temperature no greater than about 300° C. A mixing temperature may be chosen depending, for example, on the polyester and the layered compound being mixed.

In certain embodiments, the polyester includes a poly(alkylene terephthalate), for example, a poly(butylene terephthalate), a poly(ethylene terephthalate), a poly(propylene terephthalate), and/or copolymer(s) thereof.

In certain embodiments, the layered compound includes those derived from (or otherwise containing) montmorillonite, kaolinite, and/or illite. In certain embodiments, prior to the mixing step, the layered compound has undergone cation exchange with quaternary ammonium cations, imidazolium cations, and/or benzimidazolium cations.

In one embodiment, the solvent includes dichlorobenzene, for example, ortho-dichlorobenzene. In certain embodiments, the solvent includes, for example, tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether (or a halogenated derivative thereof), anisole, dimethoxybenzene, chlorobenzene, trichlorobenzene, chloronaphthalene, dichloronaphthalene, and/or a perfluorocarbon.

One embodiment of the invention is directed to a composite produced following the mixing step. In certain embodiments, the composite is a nanocomposite. In one embodiment, the layered compound in the composite is substantially exfoliated following the mixing step, for example, where the layered compound was either non-exfoliated or partially-exfoliated prior to the mixing step. In certain embodiments, the layered compound is at least partially non-exfoliated following the mixing step. In a preferred embodiment, the layered compound is substantially homogeneously dispersed in the composite following the mixing step. In certain embodiments, the organoclay is substantially homogeneously dispersed in the polymer matrix without exfoliation or with only partial exfoliation, as shown, for instance, in Example 2. Even without exfoliation or with only partial exfoliation of the layered compound, homogeneous dispersion of the layered compound in the polymer matrix may be beneficial, for example, by reducing or eliminating defects in manufactured parts caused by the presence of large particles or particle agglomerates. Such agglomerates may result in mechanical failure of parts. Other advantages of exfoliation and/or homogeneous dispersion of the layered compound in the polymer matrix may include, for example, improvement in mechanical properties of the composite, for example, stiffness, modulus, hardness, tensile strength, impact strength, density, tear strength, rupture energy, cracking resistance, resilience, dynamic properties, flex life, abrasion resistance, wear resistance, color retention, and/or chemical resistance

### BRIEF DESCRIPTION OF THE DRAWINGS

The objects and features of the invention can be better understood with reference to the drawings described below, and the claims.

FIGS. 1A, 1B, and 1C are schematic diagrams that illustrate methods of performing a polycondensation reaction in a solvent and in the presence of a layered compound, according to illustrative embodiments of the invention.

FIG. 2 shows a graph of quantitative data from a wide angle x-ray diffraction (WAX) experiment of a PBT-based composite made with a montmorillonite-based organoclay in ortho-dichlorobenzene (oDCB) solvent, according to an illustrative embodiment of the invention; the graph indicates the organoclay in the PBT composite is exfoliated.

FIG. 3 shows a graph of quantitative data from a WAX experiment of a PBT-based composite made with an imidazolium cation-based organoclay in ortho-dichlorobenzene (oDCB) solvent, according to an illustrative embodiment of the invention; the graph indicates the organoclay in the PBT composite is not exfoliated, although it is homogeneously dispersed.

FIG. 4 shows a graph of quantitative data from a WAX experiment of a PBT-based composite made via in-situ polycondensation in the presence of an imidazolium cation-based organoclay in ortho-dichlorobenzene (oDCB) solvent, according to an illustrative embodiment of the invention; the graph indicates the organoclay in the PBT composite is partially exfoliated.

### DETAILED DESCRIPTION

Polyester composites are made by performing a polycondensation reaction in a solvent and in the presence of a layered compound. For example, PBT composites can be produced by in-situ polycondensation of dimethyl terephthalate and butanediol in the presence of a polymerization catalyst and cation-modified clay in solvent.

As used herein, a “layered compound” includes layered minerals, clays, and other compounds, including organic, inorganic, natural, and/or synthetic compounds. A “layered compound” includes, for example, modified layered compounds—for example, clays modified by cation exchange—as well as other layered compound derivatives. In general, a layered compound is composed of a substantially parallel assembly of substantially planar layers. Each of the layers generally contains covalently-bonded atoms arranged in a substantially planar fashion, where ionic and/or secondary dispersion forces exist between layers. Each layer may include a single layer of atoms, or multiple layers of atoms. As the term is used herein, a “layered compound” may be exfoliated or may become exfoliated and still be considered a “layered compound”; in other words, a composite containing exfoliated clay is still considered to contain a “layered compound,” even though the clay layers have been separated during the process of exfoliation.

Preferably, the layered compound is made more compatible with the polyester by undergoing a cation exchange before its use in the polycondensation reaction. Cations, as used herein, are positively charged organic ions and may be derived from heteroaliphatic, heteroalicyclic, and/or heteroaromatic compounds, any of which may be substituted or unsubstituted.

Furthermore, dispersions of layered compounds in polyesters such as PBT can be achieved by directly mixing the layered compound and the polyester together in the presence of a solvent. Preferably, the layered compound is made more compatible with the polyester by undergoing a cation exchange before being mixed with the polyester. The use of a solvent allows mixing at relatively low temperatures and/or at low shear, thereby reducing or eliminating the formation of decomposition byproducts during mixing, and allowing the composition to maintain high molecular weight. The solvent serves as a solubilizer and a dispersing agent, for example, providing a low viscosity medium for improved mixing of polymer and clay and providing improved nano-scale dispersion of the clay itself.

For example, ortho-dichlorobenzene (oDCB) is found to assist in achieving a nano-scale dispersed clay in PBT by both solubilizing the PBT polymer as well as dispersing the clay. The solvent also enables the use of lower mixing temperatures versus melt compounding, since sufficient dispersion can be achieved by mixing at temperatures at or below the boiling point of the solvent. It is also possible to mix using lower shear because of the lower viscosity of the mixture and because high shear is not necessary to obtain adequate dispersion of organoclay in the polymer matrix.

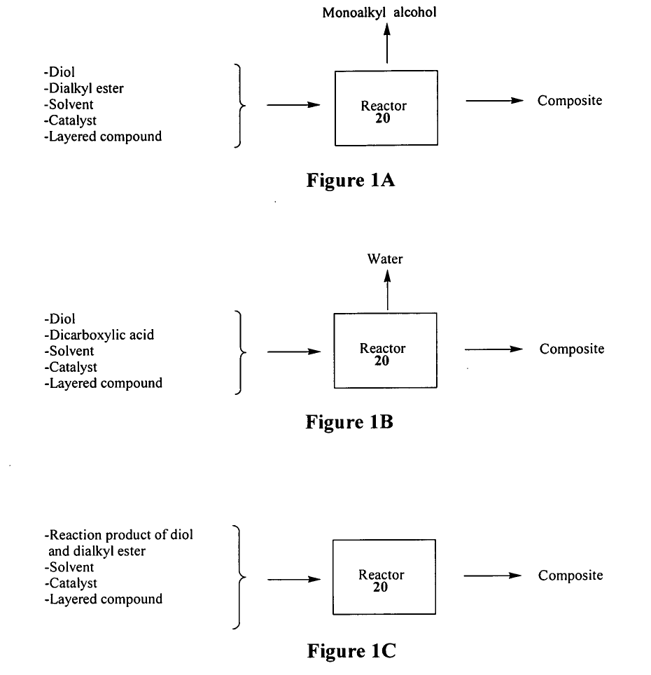

FIGS. 1A, 1B, and 1C are schematic diagrams of methods of performing a polycondensation reaction in a solvent and in the presence of a layered compound, according to various embodiments of the invention.

In FIG. 1A, a diol, a dialkyl ester, a solvent, a catalyst, and a layered compound (for example, an ion-modified clay) are contacted in a reactor 20 to form a composite of poly(alkylene dicarboxylate) and the layered compound. The diol, dialkyl ester, solvent, catalyst, and layered compound can be introduced in the reactor 20 in any particular order. The components may be introduced into the reactor 20 in separate streams, or two or more components can be premixed before being introduced into the reactor 20. The reactor 20 in FIG. 1A may represent one or more stages of a reactor system, or may be part of a larger reactor or processing system; the reactor 20 is not limited to one vessel or one stage. The diol and the dialkyl ester are reactants in the formation of the poly(alkylene dicarboxylate) matrix of the composite. In certain embodiments, the dialkyl ester reacts with the diol in a transesterification step, followed by polycondensation of the transesterification reaction product. For example, the reactor 20 may represent one or more single- and/or multi-stage reactor vessels in a polycondensation reaction system in which one or more of the following unit operations takes place: transesterification, prepolycondensation, and polycondensation. Also, more than one diol, dialkyl ester, solvent, catalyst, and/or layered compound may be used, and/or other components may be added to the reactor 20.

In FIG. 1B, a diol, a dicarboxylic acid, a solvent, a catalyst, and a layered compound are contacted in a reactor 20 to form a composite of poly(alkylene dicarboxylate) and the layered compound. The diol, carboxylic acid, solvent, catalyst, and layered compound can be introduced in the reactor 20 in any particular order. The components may be introduced into the reactor 20 in separate streams, or two or more components can be premixed before being introduced into the reactor. The reactor 20 in FIG. 1B may represent one or more stages of a reactor system, or may be part of a larger reactor or processing system; the reactor 20 is not limited to one vessel or one stage. The diol and the carboxylic acid are reactants in the formation of the poly(alkylene dicarboxylate) matrix of the composite. In certain embodiments, the dicarboxylic acid is a precursor of a dialkyl ester that reacts with the diol in a transesterification step, followed by polycondensation of the transesterification reaction product. For example, the reactor 20 may represent one or more single- and/or multi-stage reactor vessels in a polycondensation reaction system in which one or more of the following unit operations takes place: transesterification, prepolycondensation, and polycondensation. Also, more than one diol, dicarboxylic acid, solvent, catalyst, and/or layered compound may be used, and/or other components may be added to the reactor 20.

Because a diol and a dialkyl ester may react to form a reaction product that then undergoes polycondensation, there may not be contact of the diol and/or the dialkyl ester with the solvent and/or layered compound if the solvent and/or layered compound are added after the diol and/or dialkyl ester have reacted away. This situation is shown in FIG. 1C, where the reaction product of a diol and dialkyl ester is in contact with solvent, catalyst, and a layered compound to form a composite of poly(alkylene dicarboxylate) and the layered compound. As described with respect to FIGS. 1A and 1B, the reaction product of diol and dialkyl ester, the solvent, the catalyst, and the layered compound can be introduced in the reactor 20 in any particular order. The components may be introduced into the reactor 20 in separate streams, or two or more components can be premixed before being introduced into the reactor. The reactor 20 in FIG. 1C may represent one or more stages of a reactor system, or may be part of a larger reactor or processing system; the reactor 20 is not limited to one vessel or one stage. The reaction product of diol and dialkyl ester (either isolated or non-isolated) polycondenses to form the polymer matrix of the composite. For example, the reactor 20 may represent one or more single- and/or multi-stage reactor vessels in a polycondensation reaction system in which pre-polycondensation and/or polycondensation unit operation(s) take place. More than one reaction product of diol and dialkyl ester and/or more than one solvent, catalyst, and/or layered compound may be used, and/or other components may be added to the reactor 20.

Throughout the description, where compositions, mixtures, blends, and composites are described as having, including, or comprising specific components, or where processes and methods are described as having, including, or comprising specific steps, it is contemplated that, additionally, there are compositions, mixtures, blends, and composites of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously. Elements described with respect to one aspect of the invention may be used with respect to other aspects, so long as the invention remains operable.

The mention herein of any publication, for example, in the Background section, is not an admission that the publication serves as prior art with respect to any of the claims presented herein. The Background section is presented for purposes of clarity and is not meant as a description of prior art with respect to any claim.

Methods of the invention may be performed as part of a continuous, semi-continuous, or batch process. Reactors may be single-stage or multi-stage. It is contemplated that the methods described may be combined or supplemented with reactors, systems, and/or processes that are known in the art.

Any suitable organic solvent may be used. For example, tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether (or a halogenated derivative thereof), anisole, dimethoxybenzene, chlorobenzene, dichlorobenzene, trichlorobenzene, chloronaphthalene, dichloronaphthalene, and/or a perfluorocarbon, can be used. In some embodiments, solvents with amine groups should be avoided; however, perfluoramine may behave differently from other amines and may be suitable for some embodiments.

Suitable catalysts that may be used in various embodiments generally include catalysts that are capable of catalyzing a polycondensation reaction. The catalyst can include, for example, a metal oxide, antimony oxide, a transition metal salt, zinc acetate, cobalt acetate, a mercury salt, a lead salt, a cadmium salt, a manganese salt, a chromium salt, a molybdenum salt, a tungsten salt, a tin compound, and/or a titanate compound.

Where embodiments for producing composites with poly(butylene terephthalate) (PBT) are described, it is contemplated that alternative embodiments of the invention include methods for producing composites with polymers other than PBT, for example, other poly(alkylene terephthalates) such as poly(ethylene terephthalate), poly(propylene terephthalate), and copolymers thereof, as well as poly(alkylene isophthalates), including poly(butylene isophthalate). Furthermore, it is contemplated that alternative embodiments of the invention include methods for preparing composites with poly(alkylene dicarboxylates) other than poly(alkylene terephthalates).

Scale-up of systems from laboratory to plant scale may be performed by those of ordinary skill in the field of polymer manufacturing and processing. For example, those of ordinary skill in this field may select reactor types, design experiments for obtaining kinetic data, develop and apply models for reactor design, develop economically optimum reactor design, and/or validate reactor designs via pilot plant and/or full scale reactor experiments. General information regarding reactors and the design of reactor systems for manufacture of products may be found, for example, in “Kinetics and Reaction Engineering,” John L. Falconer, editor, in The Engineering Handbook, Section X, Richard C. Dorf, editor-in-chief, CRC Press, Inc., ISBN 0-8493-8344-7, pp. 785-829 (1995).

Any suitable technique for material separation, isolation, and purification may be adapted for application in manufacturing processes, for example, techniques for distillation, extraction, reactive extraction, adsorption, absorption, stripping, crystallization, evaporation, sublimation, diffusional separation, adsorptive bubble separation, membrane separation, and/or fluid-particle separation. General information regarding separation processes and their design may be found, for example, in “Separation Processes,” Klaus Timmerhaus, editor, in The Engineering Handbook, Section VIII, Richard C. Dorf, editor-in-chief, CRC Press, Inc., ISBN 0-8493-8344-7, pp. 579-657 (1995).

It is also contemplated that methods, systems, and processes of the claimed invention may include mixers, pumps, heat exchangers, and gas-, liquid-, and/or solid-phase material handling equipment known to those of ordinary skill in the field of polymer composite manufacturing. In certain embodiments, mixing equipment (mixers, blenders, extruders, pultruders, mixing mills, tilt body dispersion mixers, kneaders, and other such processing equipment) capable of operating at low-shear is preferred.

A process for manufacturing PBT typically includes a series of reactors for performing transesterification and polycondensation reactions. Such a process may be adapted to produce PBT-based clay nanocomposites according to embodiments of the present invention.

The transesterification step in the production of PBT generally involves reacting dimethyl terephthalate (DMT) with excess 1,4-butanediol (BDO) in the presence of a catalyst to form bishydroxylbutyl terephthalate (BDO ester), as well as other compounds. This is an equilibrium reaction and is driven forward by removal of the methanol produced.

The polycondensation step in the production of PBT involves the use of heat and vacuum to polymerize the transesterification reaction product. The transesterification reaction product polymerizes upon heating in the presence of a catalyst to form PBT. This polycondensation reaction is an equilibrium reaction and is driven forward by removal of the BDO produced.

A typical industrial process for making PBT includes unit operations for handling raw materials and products, as well as a series of reactors for performing transesterification, prepolycondensation, polycondensation, and/or solid state polymerization. It is contemplated that embodiments of the invention cover processes in which a layered compound and solvent are part of a reaction mixture in any one or more of the following unit operations: transesterification, prepolycondensation, and polycondensation.

Transesterification may be performed in a single- or multi-stage reactor. In general, dimethyl terephthalate (DMT) and butanediol (BDO) are mixed and heated as they are fed into the reactor. The reaction mixture boils as methanol and tetrahydrofuran (THF) are produced. The methanol vapor is condensed and recovered in a condenser.

A prepolycondensation step is then typically performed using one or more reactors operating at high temperature and low pressure (i.e. vacuum). In a prepolycondensation step, BDO produced during polymerization is removed using heat and vacuum. The BDO and final traces of methanol are recovered using condensers. A pump forwards molten polymer through a mixer, where stabilizers and additives may be introduced.

Polycondensation is the final stage of melt polymerization. Polycondensation may require a special reactor, for example, a rotating disc reactor such as a Vickers-Zimmer reactor, in order to facilitate the removal of BDO that drives polymerization. The polycondensation reactor can be designed to remove BDO by providing a large amount of continuously-renewed surface area. BDO is removed in order to build the molecular weight of the PBT matrix.

A solid state polymerization step may be performed after melt polymerization in order to increase the molecular weight of the PBT matrix. Solid state polymerization involves pelletizing the polymer composite produced in the polycondensation step and heating the pellets in a fixed bed until crystallization occurs. The polymer is then maintained at high temperature (i.e., 200° C.) while a stream of inert gas passes through the fixed bed to carry away the BDO formed during polymerization.

Methods for the conversion of purified terephthalic acid (PTA) to DMT are known. Therefore, embodiments of the invention that employ DMT may alternatively employ PTA, for example, where DMT is formed from PTA. For example, it may be particularly advantageous to use PTA to produce DMT as a non-isolated (or isolated) intermediate where PTA is considerably less expensive than DMT. Similarly, the use of known chemical analogues and/or precursors of chemical species described herein are considered within the scope of embodiments of the invention.

### EXPERIMENTAL EXAMPLES

Experiments were conducted to demonstrate various embodiments of the invention. For example, two general techniques for producing poly(butylene terephthalate) (PBT)-based clay nanocomposites are demonstrated in the experiments. Both involve low-temperature, low shear, and make use of a solvent.

In the first technique, PBT polymer and a commercially-available organoclay are combined in ortho-dichlorobenzene (oDCB) at less than about 200° C., for example, at about 180° C., followed by cooling and isolation of the PBT-clay precipitate. The resulting mixture presents a high level of nano-scale dispersion as indicated by wide angle x-ray diffraction (WAX).

A second technique involves combining dimethyl terephthalate (DMT), butanediol (BDO) (and/or a reaction product of DMT and BDO), and titanate or tin polymerization catalyst in oDCB at less than about 200° C., for example, at about 180° C., in the presence of a thermally-stable clay. Removal of methanol results in in-situ condensation polymerization, yielding a PBT-clay nanocomposite material. It is preferable, but not necessary, to use a more thermally-stable clay—for example, an imidazolinium-based organoclay—than typical commercially-available clay materials—for example, quaternary ammonium-based organoclays—due to decomposition of the latter during polymerization and possible deactivation of catalyst. The resulting x-ray data is similar to that reported for extrusion melt compounded PBT-clay nanocomposites.

The experiments employed the use of 1,4-butanediol (BDO) from Avocado Research Chemicals, Ltd. of Morecambe, United Kingdom. The BDO may be dried over a molecular sieve to contain no more than about 50 ppm water prior to use. Dimethyl terephthalate (DMT) (99+%) was obtained from Aldrich Chemical Co. of St. Louis, Mo., and was used without further purification. The anhydrous ortho-dichlorobenzene solvent (oDCB) was obtained from EM Science of Gibbstown, N.J., and was used without further purification. The commercial source of polybutylene terephthalate (PBT) used in the experiments is Valox® 315, manufactured by GE Plastics of Pittsfield, Mass., a melt-polymerized PBT. The tetraisopropyl titanate catalyst was manufactured by Gelest, Inc., of Morrisville, Pa. Organoclays used in the experiments include Cloisite 30B, a CH₃N⁺(CH₂CH₂OH)₂(tallow)₁/montmorillonite, produced by Southern Clay Products, Inc., of Gonzales, Tex., as well as montmorillonite exchanged with 1-(2-hydroxyethyl)-3-(octadecyl)imidazolium cation.

The montmorillonite exchanged with 1-(2-hydroxyethyl)-3-(octadecyl) imidazolium cation was prepared by first preparing 1-(2-hydroxyethyl)imidazole: 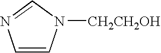
then preparing 1-(2-hydroxyethyl)-3-(octadecyl)imidazolium bromide: 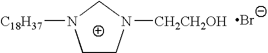
then preparing montmorillonite exchanged with 1-(2-hydroxyethyl)-3-(octadecyl) imidazolium cation.

The compound 1-(2-hydroxyethyl)imidazole was prepared as follows. 20.72 g of imidazole, 25 ml of toluene and 75 ml of THF were placed in a 250 ml, three-necked flask. The mixture was stirred under argon and 12.2 g of coarsely ground sodium hydroxide was added. To this mixture, 2-chloroethanol (24.32 g) was added drop-wise through an addition funnel. An exothermic reaction immediately took place. The addition took approximately one hour during which time the temperature was maintained at about 55 to 60° C. After completion of the addition, the reaction mixture was further stirred at about 60 to 70° C. for an additional 0.5 hour and then allowed to cool. The solution was diluted with 100 ml of isopropanol and filtered. The filtrate was evaporated under vacuum and the residual liquid was distilled under vacuum. The main fraction boiling at about 143 to 146° C./0.1 mmHg was collected, a light yellow oil, yield 25.7 g (76%).

The compound 1-(2-hydroxyethyl)-3-(octadecyl)imidazolium bromide was then prepared as follows. 1-(2-Hydroxyethyl)imidazole (3.72 g), octadecyl bromide (12.2 g) and 10 ml of toluene were placed in a 50 ml, three neck flask, and the mixture was gradually heated under argon to its boiling point over a period of 0.5 hr. The heating at reflux (115˜120° C.) was continued for an additional one hour and the mixture was cooled. The solidified mixture was digested with 50 ml of pentane and filtered. The white crystalline solid was washed with pentane and dried under vacuum; the yield was 14.0 g (95%).

Montmorillonite exchanged with 1-(2-hydroxyethyl)-3-(octadecyl) imidazolium cation was prepared as follows. Sodium montmorillonite (10.00 g, dry weight 9.00 g, 10.71 milliequivalent) was dispersed in 500 ml of water in a blender. Separately, 1-(2-hydroxyethyl)-3-(octadecyl)imidazolium bromide (4.87 g) was dissolved in 50 ml of methanol and the solution was added to the above stirred clay dispersion along with additional 300 ml of water. The resulting white precipitate was filtered and the solid was washed with water. The wet cake of the organoclay was then freeze-dried; the yield was 12.2 g (96%).

### Example 1

### Dispersion of Cloisite 30B Organoclay in PBT

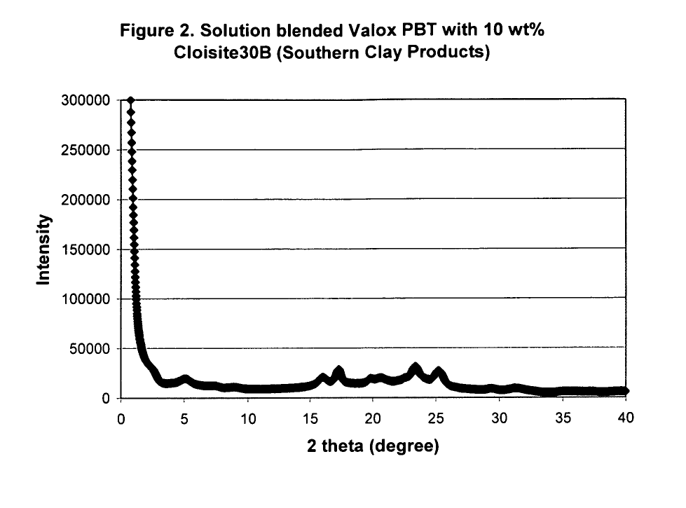

A nitrogen-blanketed flask was charged with 11.70 g of Valox® 315 PBT resin, 1.30 g of organoclay Cloisite30B, and 52 ml of dry o-dichlorobenzene (ODCB). The mixture was stirred using a Teflon-bladed paddle stirrer with stirring rate less than 120 rpm) and heated at its boiling temperature (180˜185° C.) for 5 min. The mixture formed a clear solution. On cooling to room temperature, the solution turned into a cheese-like semi-crystalline solid which was readily ground and dried under vacuum at 80˜100° C. The resulting white powder of PBT composite possessed molecular weight unchanged from that of starting Valox 315®, as measured by GPC. A part of the product was compression molded into a 1.1 mm thick sheet at 230° C. Wide-angle x-ray (WAX) diffraction of the sheet was measured over 2˜40° of 20, shown in FIG. 2. The graph of FIG. 2 shows little diffraction peak at angles below 100 and the only significant diffraction peaks are those of the background PBT itself, indicating the organoclay in the PBT composite is exfoliated. The diffraction at 18.5 Å associated with Cloisite 30B was not seen. Also, the relatively low noise of the signal is qualitatively indicative of good homogeneity.

### Example 2

### Dispersion in PBT of Organoclay Based on 1-octadecyl-3-hydroxyethyl-imidazolium cation

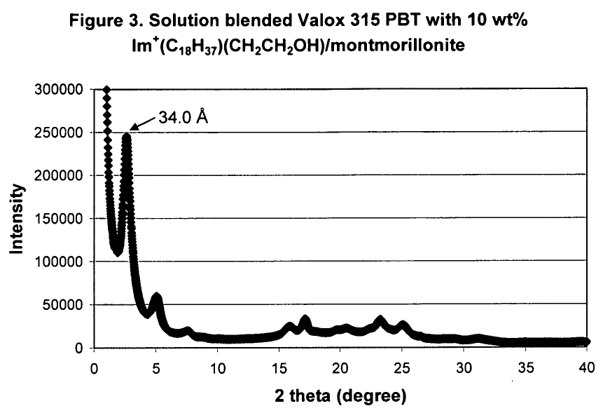

A mixture of Valox® 315 PBT resin (10.80 g), 1-octadecyl-3-hydroxyethyl imidazolium cation based organoclay (1.20 g) and 48 ml of dry ODCB was stirred under nitrogen and heated to its boiling temperature. Mixing took place in a laboratory Teflon-bladed paddle stirrer with stirring rate of less than 120 rpm. The solution was then allowed to cool to room temperature causing crystallization of the polymer. The resulting cheese-like semi-solid was ground to powder and dried under vacuum. The molecular weight of the product was essentially identical with that of starting PBT (no decrease in molecular weight was observed). As in Example 1, a WAX sample sheet of 1.1 mm thick was made by compression molding at 235° C. The diffraction measurement exhibited an intense peak at a d-spacing of 34.0 Å, shown in FIG. 3 This result indicates that organoclay in the composite is not exfoliated, although it is dispersed homogeneously, as qualitatively indicated by the lack of signal noise.

### Example 3

### In Situ Polycondensation of PBT in ODCB in the Presence of Cloisite 30B

Dimethyl terephthalate (39.67 g), butanediol (18.58 g), Cloisite 30B (5.00 g), catalyst 2,7-distanna-2,2,7,7-tetrabutyl-1,3,6,8-tetraoxacyclodecane (60 mg), and 100 ml of dry ODCB were charged in a 250 ml, 3-neck flask fitted with a distillation adaptor. The mixture was stirred with a Teflon-bladed paddle stirrer with stirring rate of less than 120 rpm under nitrogen and heated in a 200° C. oil bath. Methanol that formed was allowed to distill for the following 8 hours of heating. The product was isolated similarly by evaporation of the solvent. The peak molecular weight of the product as measured by GPC was less than 3,000 g/mol—a low molecular weight. A similar result was obtained in an experiment in which the above tin catalyst was substituted with 20 microliter of tetraisopropyl titanate.

### Example 4

### In Situ Polycondensation of PBT in ODCB in the Presence of Organoclay Based on 1-octadecyl-3-hydroxyethylimidazolium cation

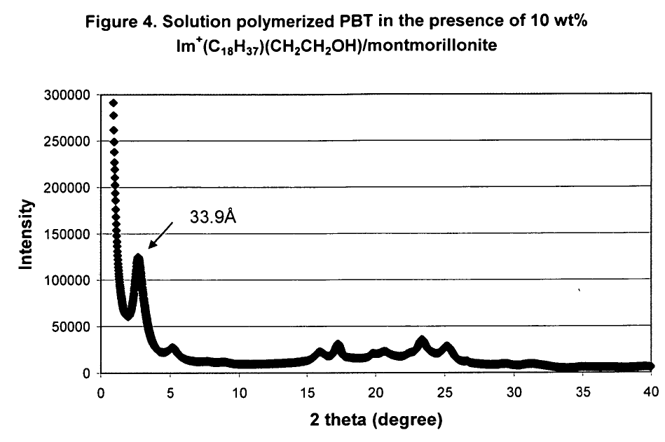

The above-referenced organoclay (3.00 g), dimethyl terephthalate (23.81 g), butanediol (11.05 g), and 60 ml of dry ODCB were charged in a 250 ml, 3-neck flask equipped with a distillation adapter. The mixture was stirred with a Teflon-bladed paddle stirrer with stirring rate of less than 120 rpm under nitrogen and heated in 200° C. oil bath. Tetraisopropyl titanate (20 μl) was added to the mixture. The methanol that formed was allowed to distill over the next 10 hours, during which time approximately 8 g of the distillate was collected. The resulting, very viscous reaction mixture was cooled to room temperature and allowed to crystallize to a hard cheese-like cake. The product was isolated by evaporation of the solvent into a white powder. The peak molecular weight of this product as measured by GPC was 35,300 g/mol (significantly higher than the peak molecular weight of the product of Example 3). As in Examples 1 and 2, a WAX sample was prepared similarly by compression molding at 235° C. The result showed a similar diffraction peak at d-spacing of 33.9 Å as described in Example 2, but its intensity was significantly lower, as shown in FIG. 4. This result indicates the organoclay is partially exfoliated.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for preparing a composite of a poly(alkylene dicarboxylate) and a layered compound, the method comprising performing a polycondensation reaction in solvent and in the presence of the layered compound.

2. The method of claim 1, wherein the poly(alkylene dicarboxylate) comprises at least one member selected from the group consisting of poly(butylene terephthalate), poly(ethylene terephthalate), poly(propylene terephthalate), and a copolymer thereof.

3. The method of claim 1, wherein the step of performing the polycondensation reaction comprises reacting a diol and a dialkyl ester in the solvent and in the presence of the layered compound.

4. The method of claim 1, wherein the step of performing the polycondensation reaction comprises reacting a diol and a carboxylic acid in the solvent and in the presence of the layered compound.

5. The method of claim 1, wherein the solvent comprises at least one member selected from the group consisting of tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether, a halogenated derivative of diphenyl ether, anisole, dimethoxybenzene, chlorobenzene, dichlorobenzene, trichlorobenzene, chloronaphthalene, dichloronaphthalene, and/or a perfluorocarbon.

6. The method of claim 1, wherein the solvent is a perfluorocarbon compound and the polycondensation reaction is performed in a supercritical fluid process.

7. The method of claim 1, wherein the polycondensation reaction is performed in the presence of a catalyst.

8. The method of claim 7, wherein the catalyst comprises at least one member selected from the group consisting of a metal oxide, antimony oxide, a transition metal salt, zinc acetate, cobalt acetate, a mercury salt, a lead salt, a cadmium salt, a manganese salt, a chromium salt, a molybdenum salt, a tungsten salt, a tin compound, and a titanate compound.

9. The method of claim 1, wherein the layered compound has undergone an ion exchange.

10. The method of claim 1, with the layered compound has undergone cation exchange with cations of at least one type selected from the group consisting of quaternary ammonium cations, imidazolium cations, and benzimidazolium cations.

11. The method of claim 1, with the layered compound has undergone cation exchange with cations that comprise at least one positively charged organo-substituted heteroatom.

12. The method of claim 11, wherein the at least one positively charged organo-substituted heteroatom comprises an N-organo-substituted salt of at least one member selected from the group consisting of pyrrole, imidazole, thiazole, oxazole, pyridine, pyrimidine, quinoline, isoquinoline, indole, purine, benzimidazole, benzothiazole, benzoxazole, pyrazine, quinoxaline, quinazoline, acridine, phenazine, imidazopyridine, and dipyridyl.

13. The method of claim 1, wherein the layered compound comprises a modified layered compound.

14. The method of claim 13, wherein the modified layered compound has been modified via cation exchange with an onium compound.

15. The method of claim 14, wherein the onium compound comprises a salt of at least one member selected from the group consisting of ammonium, phosphonium, sulfonium, pyrrolidine, piperidine, piperazine, and morpholine.

16. The method of claim 1, wherein the layered compound comprises a layered mineral selected from the group consisting of kaolinite, hallysite, dickite, nacrite, montmorillonite, nontronite, beidellite, hectorite, saponite, muscovite, vermiculite, an illite, a silicate, hydromicas, phengite, brammallite, glaucomite, celadonite, kenyaite, megadite, muscovite, sauconite, volkonskoite, a phyrophyllic, a mica, a smectite, biotite, limonite, graphite, and feldspar.

17. The method of claim 16, wherein the layered mineral is a modified layered mineral.

18. The method of claim 16, wherein the layered mineral is a layered mineral derivative.

19. The method of claim 1, wherein the layered compound comprises an organoclay.

20. The method of claim 1, wherein the layered compound comprises a synthetic clay.

21. The method of claim 1, wherein the layered compound comprises an admixture of minerals.

22. A composite produced by the method of claim 1.

23. The composite of claim 22, having a GPC peak molecular weight of at least about 10,000 g/mol.

24. The composite of claim 22, having a GPC peak molecular weight of at least about 30,000 g/mol.

25. A nanocomposite produced by the method of claim 1.

26. A method for preparing a composite comprising a poly(alkylene terephthalate) and a layered compound, the method comprising the step of contacting:
(a) one or a combination of:
(i) a diol;
(ii) a dialkyl ester;
(iii) a carboxylic acid; and
(iv) a reaction product of a diol and a dialkyl ester;
(b) a solvent;
(c), a layered compound; and
(d) a catalyst.

27. The method of claim 26, wherein the poly(alkylene terephthalate) comprises at least one member selected from the group consisting of poly(butylene terephthalate), poly(ethylene terephthalate), poly(propylene terephthalate), and a copolymer thereof.

28. The method of claim 26, wherein the poly(alkylene terephthalate) comprises poly(butylene terephthalate) and wherein the contacting step comprises contacting butanediol, dimethyl terephthalate, the solvent, the layered compound, and the catalyst.

29. The method of claim 26, wherein the poly(alkylene terephthalate) comprises poly(butylene terephthalate) and wherein the contacting step comprises contacting butanediol, terephthalic acid, the solvent, the layered compound, and the catalyst.

30. The method of claim 26, wherein the catalyst comprises at least one member selected from the group consisting of a metal oxide, antimony oxide, a transition metal salt, zinc acetate, cobalt acetate, a mercury salt, a lead salt, a cadmium salt, a manganese salt, a chromium salt, a molybdenum salt, a tungsten salt, a tin compound, and a titanate compound.

31. The method of claim 26, wherein the layered compound comprises a layered mineral having undergone an ion exchange.

32. The method of claim 26, wherein the layered compound is thermally stable at the temperature of the contacting step.

33. The method of claim 26, wherein the layered compound comprises at least one member of the group consisting of montmorillonite, kaolinite, and illite.

34. The method of claim 26, wherein the layered compound has undergone cation exchange with cations of at least one type selected from the group consisting of quaternary ammonium cations, imidazolium cations, and benzimidazolium cations.

35. The method of claim 26, wherein the solvent comprises ortho-dichlorobenzene.

36. The method of claim 26, wherein the solvent comprises at least one member selected from the group consisting of tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether, a halogenated derivative of diphenyl ether, anisole, dimethoxybenzene, chlorobenzene, dichlorobenzene, trichlorobenzene, chloronaphthalene, dichloronaphthalene, and/or a perfluorocarbon.

37. A composite produced by the method of claim 26.

38. The composite of claim 37, having a GPC peak molecular weight of at least about 10,000 g/mol.

39. The composite of claim 37, having a GPC peak molecular weight of at least about 30,000 g/mol.

40. A nanocomposite produced by the method of claim 26.

41. The method of claim 26, wherein at least one of a transesterification and a polycondensation takes place during the contacting step.

42. The method of claim 26, wherein both a transesterification and a polycondensation takes place during the contacting step.

43. A method for preparing a composite, the method comprising the step of mixing a polyester of average molecular weight greater than about 2,000 g/mol and a layered compound in the presence of a solvent, thereby forming a composite of the polyester and the organoclay.

44. The method of claim 43, wherein the polyester has average molecular weight greater than about 10,000 g/mol.

45. The method of claim 43, wherein the polyester has average molecular weight greater than about 30,000 g/mol.

46. The method of claim 43, wherein the layered compound has undergone cation exchange with quaternary ammonium cations, and wherein the mixing step is conducted at a temperature less than 220° C.

47. The method of claim 43, wherein the polyester comprises a poly(alkylene terephthalate).

48. The method of claim 43, wherein the polyester comprises at least one member selected from the group consisting of poly(butylene terephthalate), poly(ethylene terephthalate), poly(propylene terephthalate), and a copolymer thereof.

49. The method of claim 43, wherein the layered compound comprises a layered mineral having undergone an ion exchange.

50. The method of claim 43, wherein the layered compound comprises at least one member of the group consisting of montmorillonite, kaolinite, and illite.

51. The method of claim 43, wherein the layered compound has undergone cation exchange with cations of at least one type selected from the group consisting of quaternary ammonium cations, imidazolium cations, and benzimidazolium cations.

52. The method of claim 43, wherein the solvent comprises ortho-dichlorobenzene.

53. The method of claim 43, wherein the solvent comprises at least one member of the group consisting of tetradecane, hexadecane, octadecane, toluene, xylene, trimethylbenzene, tetramethylbenzene, ethylbenzene, propylbenzene, naphthalene, methylnaphthalene, biphenyl, triphenyl, diphenyl ether, a halogenated derivative of diphenyl ether, anisole, dimethoxybenzene, chlorobenzene, dichlorobenzene, trichlorobenzene, chloronaphthalene, dichloronaphthalene, and/or a perfluorocarbon.

54. The method of claim 43, wherein the mixing step is conducted at a temperature no greater than about 300° C.

55. A composite produced by the method of claim 43.

56. A nanocomposite produced by the method of claim 43.

57. The method of claim 43, wherein the layered compound in the composite is substantially exfoliated following the mixing step.

58. The method of claim 43, wherein the layered compound in the composite is at least partially non-exfoliated following the mixing step.

59. The method of claim 43, wherein the layered compound is substantially homogenously dispersed in the composite following the mixing step.
